(19) United States
(12) Patent Application Publication
(10) Pub. No.: US 2015/0059465 A1
(43) Pub. Date: Mar. 5, 2015

(54) AERODYNAMIC MEASUREMENT PROBE FOR AIRCRAFT

(71) Applicant: THALES, NEUILLY-SUR-SEINE (FR)

(72) Inventors: Henri LEBLOND, VERSAILLES (FR); Jacques MANDLE Jacques MANDLE, SAINT PERAY (FR)

(21) Appl. No.: 14/473,323

(22) Filed: Aug. 29, 2014

(30) Foreign Application Priority Data
Aug. 30, 2013 (FR) 1302016

(51) Int. Cl. G01P 13/02

(52) U.S. Cl. CPC G01P 13/025
USPC 73/170.02

(57) ABSTRACT

An aerodynamic measurement probe intended to equip an aircraft. The probe comprises a tube intended to face substantially into a flow of air along the aircraft, the tube being open at a first of its ends. The probe further emits an electromagnetic wave directed towards a free zone situated in the extension of the tube on the side of the open end, the electromagnetic wave making it possible to reheat the water likely to be located in the free zone.

### CROSS-REFERENCE TO RELATED APPLICATION

This application claims priority to foreign French patent application No. FR 1302016, filed on Aug. 30, 2013, the disclosure of which is incorporated by reference in its entirety.

### FIELD OF THE INVENTION

The invention relates to an aerodynamic measurement probe intended to equip an aircraft.

### BACKGROUND

Piloting any aircraft entails knowing the modulus of its relative speed, more precisely of its conventional speed relative to the air, that is to say to the relative wind. This speed is determined using probes for measuring the static pressure Ps and the total pressure Pt. Pt−Ps gives the modulus of this conventional speed vector. This aerodynamic parameter makes it possible to determine the modulus of the speed of any aircraft, such as, for example, an aeroplane, a helicopter or an unmanned craft such as a drone.

The measurement of the total pressure Pt is usually done using a so-called Pitot tube. This is a tube that is open at one of its ends and blocked at the other. The open end of the tube substantially faces into the flow.

The stream of air situated upstream of the tube is progressively slowed down until it reaches an almost zero speed at the tube inlet. The slowing down of the speed of the air increases the air pressure. This increased pressure forms the total pressure Pt of the air flow: inside the Pitot tube, the air pressure prevailing therein is measured.

The duly determined speed can also be expressed as a Mach number M, that is to say its ratio to the speed of sound in the air surrounding the aircraft. This speed of sound is itself a function of the static temperature of the air.

On board a fast aircraft, the static temperature of the surrounding air is very difficult, even impossible, to measure. It would entail placing a temperature sensor at the bottom of a hole substantially at right angles to the outer surface of the aircraft in an area where the outer surface is substantially parallel to the flow of air with a local speed close to the upstream speed. This temperature sensor would notably be disturbed by the temperature of the outer surface which would risk corrupting the static temperature measurement. It is therefore preferable to measure the total temperature Tt of the flow of air by placing the temperature sensor in the flow of air by means of a tube similar to a Pitot tube.

The total temperature is a function of the static temperature and of the speed of the flow always expressed as a Mach number M.

The Pitot tubes and the total temperature measurement probes both have a tube facing into the flow. Based on the atmospheric conditions in which the aircraft can move, provision is made to trap the water likely to penetrate into the tube. Drain holes make it possible to discharge the duly trapped water. To be able to operate in icy conditions, the tube is electrically reheated. The reheating prevents the tube from being blocked by ice, during flights in icy conditions. The reheating also makes it possible to avoid the formation and the build-up of ice in the drain holes which would be detrimental to their role of discharging water penetrating into the tube in flight or on the ground. The dimensioning of the reheating is notably performed as a function of the atmospheric conditions that the probe may be required to encounter, as a function of the quantity of water that the probe is likely to ingest and as a function of the heat exchanges with the flow that the probe may be subjected to.

The electrical power needed for the reheating of such a probe can be as much as several hundreds of watts.

### SUMMARY OF THE INVENTION

The invention aims to propose a novel aerodynamic measurement probe with reduced electrical consumption while retaining the same level of performance. The invention seeks to limit the penetration of particles of ice or of supercooled liquid water in the tube. Thus, it is possible to very significantly reduce the reheating.

To this end, the subject of the invention is an aerodynamic measurement probe intended to equip an aircraft, the probe comprising a tube intended to face substantially into a flow of air along the aircraft, the tube being open at a first of its ends, a transmitter for emitting an electromagnetic wave directed towards a free zone situated in the extension of the tube on the side of the open end, the electromagnetic wave making it possible to reheat the water likely to be located in the free zone.

The probe can comprise temperature measurement and/or pressure measurement means.

In an advantageous configuration of the invention, the electromagnetic wave is directed towards the free zone by the inside of the tube. This arrangement also makes it possible to reheat the walls of the tube and makes it possible to eliminate any particles of ice (or of supercooled water) that might have penetrated into the tube. The reheating of the walls of the tube makes it possible to dispense with any heating resistor incorporated in the walls of the tube, or at the very least to limit its use. The means for emitting the electromagnetic wave can be positioned inside the tube or outside while retaining a path of the electromagnetic wave via the inside of the tube upstream of the free zone.

### BRIEF DESCRIPTION OF THE DRAWINGS

The invention will be better understood, and other advantages will become apparent, on reading the detailed description of an embodiment given as an example, the description being illustrated by the attached drawing in which:

FIG. 1 represents an aerodynamic measurement probe comprising total pressure measurement means;

FIG. 2 represents an aerodynamic measurement probe comprising total temperature measurement means;

FIG. 3 represents an aerodynamic measurement probe comprising total pressure and total temperature measurement means;

FIG. 4 represents a mobile aerodynamic measurement probe;

FIG. 5 represents a variant aerodynamic measurement probe comprising total pressure measurement means.

In the interests of clarity, the same elements will bear the same references in the different figures.

### DETAILED DESCRIPTION

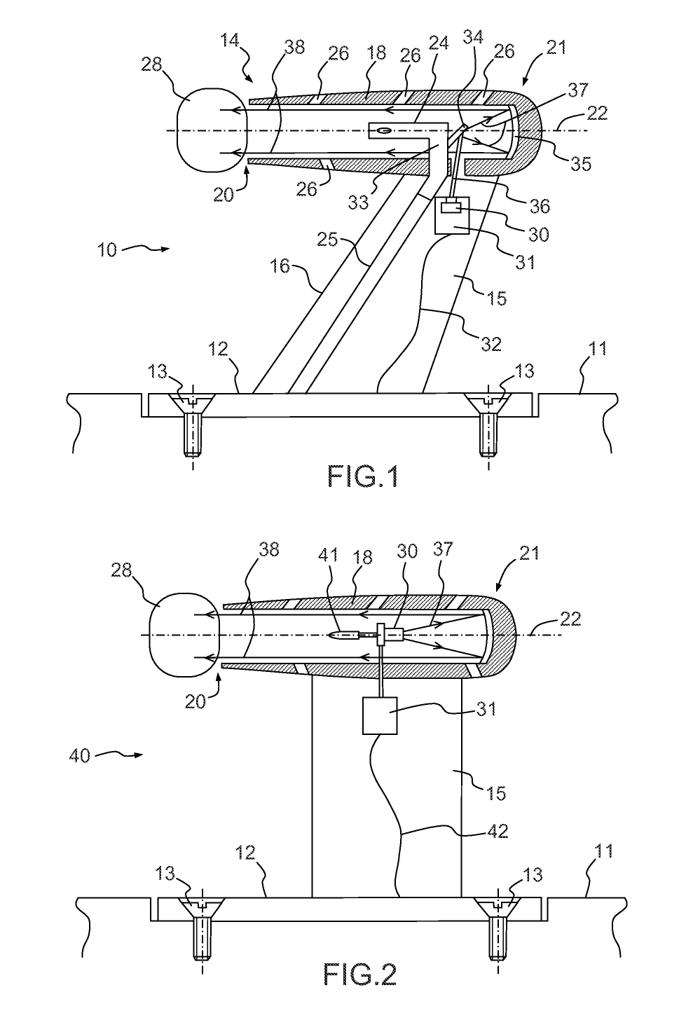

The probe 10 represented in FIG. 1 makes it possible to measure the total pressure of a flow of air circulating along the outer surface 11 of an aircraft. The probe 10 comprises a base 12 intended to be fixed onto the outer surface 11, for example by means of screws 13. The base 12 is essentially formed by a plate fixed in the extension of the outer surface 11. The probe 10 essentially comprises a Pitot tube 14 secured to a strut 15 linking the Pitot tube 14 to the base 12. Aerodynamic measurement probes are found positioned at different points of an aircraft, such as, for example, at the nose of the aircraft, fixed to its outer surface, often called skin of the aircraft. There are also probes in the air inlet of an engine of the aircraft. The invention can be implemented for any type of probe whatever its position on the outer surface of the aircraft.

The strut 15 for example has a wing profile having a plane of symmetry, situated in the plane of the figure. The profile of the wing at right angles to its leading edge 16 is, for example, a profile with low overspeed. In the example represented, the leading edge is substantially rectilinear. It is obvious that other strut shapes can be used to implement the invention.

The Pitot tube 14 comprises a tube 18 extending between two ends, one 20 open and the other 21 blocked, the tube extends substantially rectilinearly along an axis 22 between its two ends 20 and 21.

The probe 10 is positioned on the outer surface 11 of the aircraft so as to face substantially into the flow of air circulating along the base 12 when the aircraft is in flight. In other words, the probe is configured to perform an aerodynamic measurement of a flow of air along the base 12. A stream of air of the flow situated upstream of the tube is progressively slowed down until it reaches an almost zero speed at the inlet of the tube. The slowing down of the speed of the air increases the air pressure. This increased pressure forms the total pressure Pt of the flow of air.

The Pitot tube 14 comprises a pressure tap 24 positioned inside the tube 18 on the axis 22 between the two ends 20 and 21. The pressure tap 24 measures the pressure prevailing inside the tube 18. The pressure tap 24 is linked to a pressure sensor, not represented, which can be positioned inside the outer surface 11 of the aircraft. In this case, the pressure tap 24 is linked to the pressure sensor via an aeraulic channel 25 arranged in the strut 15 between the tube 18 and the base 12.

The Pitot tube 14 can comprise a few drain holes 26 arranged crossing the tube 18 and making it possible to discharge any solid or liquid particles likely to penetrate inside the tube 18.

According to the invention, the probe 10 comprises means for emitting an electromagnetic wave directed towards a free zone 28 situated in the extension of the tube 18 on the side of the open end 20, the electromagnetic wave making it possible to reheat the water situated in the free zone. In other words the means for emitting are a transmitter, The water to be reheated can consist of liquid water droplets, in the supercooled state or not, or of ice crystals present in the atmosphere, in a cloud. The electromagnetic wave advantageously has a sufficient power to reheat these water droplets and transform the ice crystals into liquid water upstream of the end 20. In severe cases of icy conditions, the flow may contain supercooled water droplets. The electromagnetic wave then reheats the supercooled water droplets, converting them into normal liquid water droplets which do not risk solidifying abruptly upon impact with a part of the probe. It is thus possible to reduce, in all cases, the power needed to reheat the probe. In the same atmospheric conditions, it has been found, that by implementing the invention, the sum of the powers needed to power the means for emitting an electromagnetic wave and for a residual reheating of the probe remains less than the power needed for a conventional reheating that is necessary in a probe with no means for emitting an electromagnetic wave.

Furthermore, inside a conventional Pitot tube, there is positioned a water trap making it possible to prevent the water penetrating into the tube from penetrating more deeply into the aeraulic channels. The water trap is linked to a drain hole passing through a wall of the tube and making it possible to drain the duly trapped water. By implementing the invention, because of the lesser penetration of water into the tube, it is possible to significantly reduce the dimensions of the water trap and of the drain hole.

Any electromagnetic wave transporting energy in sufficient quantity to reheat water can be implemented in the invention. The wavelength of the electromagnetic wave is advantageously chosen to excite mainly the molecules of water so as to enable them to vaporize. It is for example possible to use an electromagnetic wave in a frequency band used in the radar systems. The means for emitting an electromagnetic wave can be situated inside or outside the probe 10 in immediate proximity thereto. These means are dedicated to the reheating of the water likely to be located in the free zone 28.

Tests carried out on the premises of the applicant have shown that an infrared light electromagnetic wave is particularly well suited. An incoherent wave can be implemented in the invention. Advantageously, the electromagnetic wave is a laser beam that can be easily collimated towards the free zone 28.

Advantageously, the means for emitting an electromagnetic wave comprise a laser diode 30 emitting a laser beam and means for focusing the laser beam towards the zone 28, in other words, a focuser.

In the variant represented in FIG. 1, the laser diode 30 and power supply means 31 for the diode 30 are positioned in the strut 15. An electrical cable 32 connects the power supply means 31 to an electrical connector (not represented) of the probe 10 arranged at the level of the base 12 and enabling the aircraft to power the probe 10 electrically. The electrical connector can also power probe reheating means in addition to the means for emitting an electromagnetic wave.

In the example represented, the focusing means comprise a planar mirror 34 and a concave mirror 35 both arranged inside the tube 18. The planar mirror 34 is for example fixed onto a support 33 of the pressure tap 24 and the concave mirror 35 is for example fixed at the blocked end 21 of the tube 18. The beam emitted by the laser diode 30 is returned towards the concave mirror 35 by the planar mirror 34. The concave mirror 35 directs the beam towards the free zone 28. In FIG. 1, between the diode 30 and the planar mirror 34, the beam is represented by a line 36. Between the planar mirror 34 and the concave mirror 35, the beam is represented by a line 37 and between the concave mirror 35 and the free zone 28; the beam is represented by a line 38.

The line 38 runs along the internal walls of the tube 18. In the example represented, the line 38 is parallel to the axis 22 of the tube 14. It is also possible to offset the line 38, for example to take into account the constraints of designing the probe 10, constraints notably due to the presence of the pressure tap 24 and its aeraulic connection to the interior of the tube 18. Over its entire path, the beam can contribute to reheating the internal walls of the tube 18, notably between the concave mirror 35 and the free zone 28. Conventionally, the reheating of the tube 18 is performed by means of a heating resistor wound on the internal walls of the tube. By implementing the invention, it is possible to dispense with this resistor by using only the beam to reheat the tube 18. Alternatively, it is possible to provide a residual reheating of the tube 18 by winding a resistor along the internal walls of the tube 18. This resistor will be of a power significantly lower than that of a conventional Pitot tube for two reasons: first of all, because of the possible lesser presence of water in the tube 18 and then because of the reheating of the tube 18 obtained by the means for emitting an electromagnetic wave. This resistor of lower power makes it possible to reduce its dimensions and consequently to reduce the section of the tube 18. A tube of smaller section has a smaller outer surface, which makes it possible to reduce the heat exchange that it undergoes in the flow. The reduction of this heat exchange further contributes to reducing the electrical power consumed by the probe.

FIG. 2 represents a probe 40 making it possible to measure the total temperature of a flow of air circulating along the outer surface 11 of an aircraft. In the probe 40, there are the base 12 fixed onto the outer surface 11, by means of the screws 13, the tube 18 and the strut 15 linking the tube 18 and the base 12. As previously, the tube 18 can comprise a few drain holes 26 arranged across the tube 18 and making it possible to discharge any particles likely to penetrate inside the tube 18.

The probe 40 comprises a temperature sensor 41 positioned inside the tube 18, for example on the axis 22 between the two ends 20 and 21. The temperature sensor 41 measures the temperature prevailing inside the tube 18. The measured temperature is representative of the total temperature of the flow. The temperature sensor 41 delivers a measurement, for example in the form of an electrical signal, that it transmits to the aircraft via a cable 42 arranged in the strut 15.

The probe 40 comprises, like the probe 20, means for emitting an electromagnetic wave directed towards the free zone 28. As for the probe 20, the probe 40 can comprise a laser diode 30 positioned in the strut 15. As an alternative, as represented in FIG. 2, the diode 30 can be positioned inside the tube 18. The diode 30 can be positioned on the axis 22 or offset notably to facilitate its connection to the power supply means 31. The positioning of the diode 30 inside the tube can also be implemented in the probe 10. The diode 30 directs the beam that it emits towards the blocked end 21 of the tube 18 along the line 37. The concave mirror 35 is once again fixed at the blocked end 21. The mirror 35 receives the beam from the diode 30 and returns it towards the free zone 28 substantially parallel to the axis 22 of the tube 18 along the line 38. The probe 40 also contains the power supply means 31 for the diode 30 positioned in the strut 15. The signal from the temperature sensor 41 can pass through the power supply means 31. The electrical energy necessary for the power supply means 31 can be carried by the cable 42.

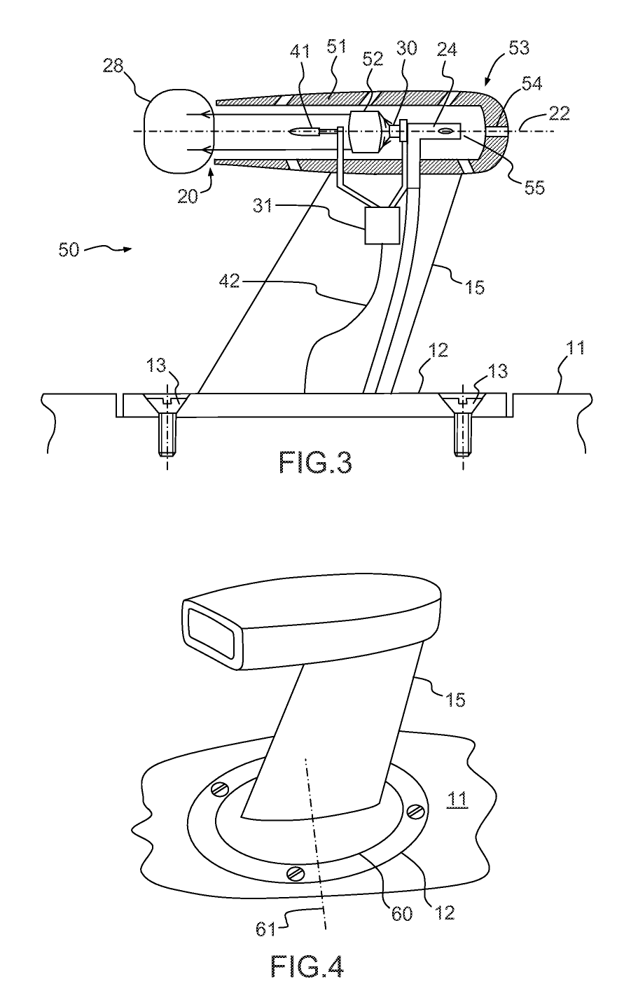

FIG. 3 represents a probe 50 making it possible to measure both the total temperature and the total pressure of a flow of air.

A tube 51 differs slightly from the tube 18. Inside the tube 51, there are the temperature sensor 41, the pressure tap 24 and the diode 30. The temperature sensor 41 is situated closer to the open end 20 than the pressure tap 24. The diode 30 and the focusing means for the light beam from the diode 30 are advantageously positioned between the temperature sensor 41 and the pressure tap 24. The focusing means comprise, for example, a lens 52 making it possible to direct the beam from the diode towards the free zone 28.

Advantageously, the total pressure is measured at a fluid stopping point. The principle of such a measurement is described in the patent application FR 2 823 846 filed on 24 Apr. 2001 in the name of the applicant. The tube 51 comprises an open end 20 intended to face into the flow in which the probe 50 is situated. The tube 51 comprises another end 53 opposite the end 20 and having an opening 54 positioned along the axis 22 of the tube 51. The opening 54 is smaller than the opening of the open end 20 but nevertheless allows for a circulation of air inside the tube 51.

A number of streams of air circulate in the tube 51 annularly about a body centred on the axis 22 and here formed by the lens 52 and more generally by the focusing means for the laser beam. The different streams of air meet and are mutually slowed down in a zone 55 situated inside the tube 51 in the vicinity of the opening 54. The mutual slowing down of the streams of air in the zone 55 forms a fluid stopping point at which it is possible to measure the total pressure of the flow or at the very least a pressure value representative of the total pressure. The pressure tap 24 is situated in the zone 55 for measuring this stopping pressure.

The end 53 is partially blocked. The internal shape of the tube 51 in the vicinity of the end 53 is defined in such a way as to bring the streams of air circulating about the lens 52 into contact. The different streams of air face substantially into the zone 55 so as to form the fluid stopping point.

The probes 10, 40 and 50 can be fixed relative to the outer surface of the aircraft. For this, the strut 15 is directly fixed to the base 12. Alternatively, a probe according to the invention can be rotationally mobile so as to allow its alignment in the axis of the flow. There is thus obtained a better aerodynamic measurement by keeping the axis 22 in the axis of the flow even when the local incidence of the probe is great.

FIG. 4 represents a mobile probe comprising a pivot link 60 positioned between the strut 15 and the base 12. The pivot link 60 enables the strut 15 to rotate freely about an axis 61 at right angles to the base 12. The probe comprises a mobile part formed by the strut 15 and the tube 18 or 51 which is fixed thereto.

The orientation of the mobile part of the probe can be done naturally in the axis of the flow by virtue of the wing-shaped profile of the strut 15. It is also possible to motorize the pivot link to obtain a better alignment notably at low speeds of the flow relative to the probe.

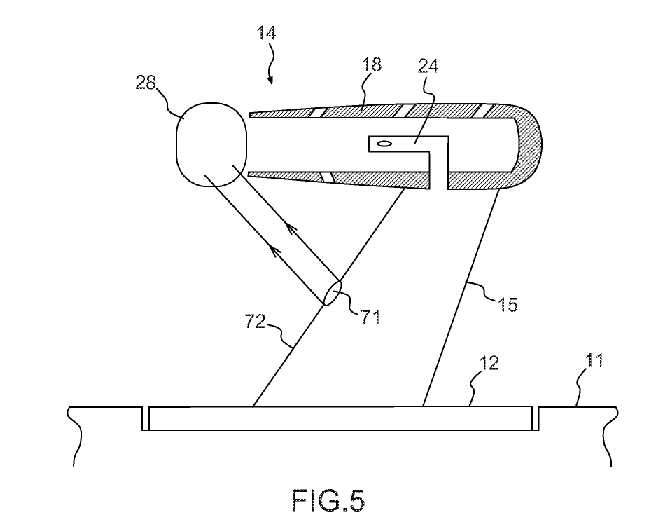

FIG. 5 represents an aerodynamic measurement probe 70 similar to that of FIG. 1. The probe 70 comprises a tube 18 equipped with its pressure tap 24. The tube 18 is secured to the strut 15 linking the tube 18 to the base 12. Unlike the probe 10, the path of the electromagnetic radiation that makes it possible to reheat the water likely to be located in the free zone 28 does not pass inside the tube 18 but outside. This variant can of course be implemented for a probe equipped with a temperature sensor 41.

The electromagnetic wave is directed towards the free zone 28 by the outside of the tube 18 by passing through a window 71 positioned on an outer surface 72 of the strut 15. Alternatively, the window 71 can be positioned on an outer surface of the base 12.

The means for emitting the electromagnetic wave can be situated directly behind the window 71 inside the strut 15. This configuration is easy to implement for example when the means for emitting the electromagnetic wave comprise the diode 30. Alternatively, it is possible to site the means for emitting the electromagnetic probe inside the outer surface 11 and guide the wave by means of a waveguide. This configuration can for example be used with a waveguide taking energy from a microwave source installed on board the aircraft. This source is for example that of an embedded radar.

1. An aerodynamic measurement probe intended to equip an aircraft, the probe comprising:
a tube intended to face substantially into a flow of air along the aircraft, the tube comprising a first and a second ends, the tube being open at the first ends, and
a transmitter emitting an electromagnetic wave directed towards a free zone situated in the extension of the tube on the side of the open end, the electromagnetic wave making it possible to reheat water likely to be located in the free zone, the electromagnetic wave being directed towards the free zone by the inside of the tube.

2. The probe according to claim 1, further comprising temperature measurement means.

3. The probe according to claim 1, further comprising pressure measurement means.

4. The probe according to claim 1, wherein the electromagnetic wave is a laser beam.

5. The probe according to claim 4, wherein the emitter comprises a laser diode emitting the laser beam and a focuser focusing the laser beam.

6. The probe according to claim 5, wherein the diode is positioned inside the tube.

7. The probe according to claims 4 wherein, the tube is blocked at the second end, the focuser comprising a concave mirror positioned in the tube and fixed at the second end.

8. The probe according to claim 4, wherein the tube is partially blocked at the second end, the focuser forming a body centred on an axis of the tube, several streams of air being able to circulate in the tube angularly about the focuser , an internal shape of the tube in the vicinity of the partially blocked end forming a fluid stopping point for the streams of air an air pressure being measured at the fluid stopping point.

9. The probe according to claim 1, further comprising a base essentially formed by a plate and intended to be fixed onto an outer surface of the aircraft, the probe performing an aerodynamic measurement of a flow of air along the base.
